(19) United States
(12) Patent Application Publication
(10) Pub. No.: US 2016/0165019 A1
(43) Pub. Date: Jun. 9, 2016

(54) Terminal Equipped with a Removable Intelligent Multifunction Device

(71) Applicants: Jinrong Yang, Shanghai (CN); Ramzi Khalil Maalouf, Chevy Chase, MD (US)

(72) Inventors: Jinrong Yang, Shanghai (CN); Ramzi Khalil Maalouf, Chevy Chase, MD (US)

(21) Appl. No.: 14/677,629

(22) Filed: Apr. 2, 2015

Related U.S. Application Data
(60) Provisional application No. 62/097,350, filed on Dec. 29, 2014.

(30) Foreign Application Priority Data
Dec. 8, 2014 (CN) 201410742203.8

(51) Int. Cl. H04M 1/02; H04W 4/00; H04B 5/00; H02J 7/02

(52) U.S. Cl. CPC H04M 1/0256; H02J 7/025; H04W 4/008; H04B 5/0031

(57) ABSTRACT

Disclosed is an intelligent terminal equipped with removable function component, including the main screen device, the withdrawing apparatus inside the main screen device and removable function component in the withdrawing apparatus. The withdrawing apparatus is installed with power supply interface and data exchange interface; the main screen device includes the touchable screen, audio devices and memory; when the removable function component separates from the withdrawing apparatus, data exchange between the main screen device and removable function component is achieved via the data exchange interface. Through embodiments of the intelligent terminal, additional configuration of charger and data cable is unnecessary for the wearable device, and also provides an optimal placement method for wearable devices, in order to meet the fundamental needs of high efficiency, energy conservation and convenience.

### PRIORITY

This application claims benefit of priority to Chinese Application No. 201410742203.8, titled “An Intelligent Terminal Equipped with Removable Function Module,” filed on Dec. 8, 2014.

This application claims benefit of priority of U.S. Provisional Application Ser. No. 62/097,350, filed on Dec. 29, 2014.

This application further claims benefit of priority of U.S. application Ser. No. 14/673,452, titled “A Handheld Terminal with Integrated Wireless Appliance Control,” filed Mar. 30, 2015, the content of which is incorporated by reference herein in its entirety.

### BACKGROUND

1. Technical Field

This disclosure relates generally to a terminal, and, more specifically, to a terminal with a removable component.

2. Description of the Related Art

Currently mobile phones and intelligent peripherals are very popular daily consumer goods. In general, peripherals and mobile phones exist as two separate items. To equip the phones with greater and greater functionality, the weight of mobile phones increases. For example, the battery size is increased to support additional, power intensive functions or longer running functionality. However, no significant progress is made in the existence mode of mobile phones and peripherals. Some peripherals have a corresponding set of data cable and charging components, making use cumbersome. With some peripherals, the equipment cannot be charged while the peripheral is being used. Some peripherals are inconvenient to store. For many people, the peripherals become things of little value.

### SUMMARY OF EMBODIMENTS

Systems, methods and devices are described herein that can be combined with another device into a single combined device or wherein a portion of the device can be physically separated from the device for independent functionality. The independent devices may be referred to as a terminal (e.g., intelligent terminal) or a main screen device and a peripheral (e.g., intelligent peripheral), withdrawing apparatus, or removable function component in some embodiments, herein.

In some embodiments, a device includes a touch-based display screen, power supply and power supply interface, audio capability, memory, and one or more processors for executing instructions from the memory. The device may include a withdrawing apparatus that can be withdrawn from the device. The withdrawing apparatus may include a wireless data exchange, another power supply and power supply interface and a removable function component, in embodiments. In some embodiments, when the withdrawing apparatus is withdrawn from the device, wireless data exchange is established between the device and the removable function component of the withdrawn apparatus.

In some embodiments, a wireless data exchange interface module may establish a wireless data connection between the separated devices. For example, prior to being withdrawn, the terminal and peripheral may not communicate at all, may communicate via another channel, may communicated with regard to other types of data (e.g., types of data that are not exchanged over the wireless interface) or may communicate via a wired or physical connection. But, when the withdrawing apparatus is withdrawn, a wireless data exchange between a main screen device and a removable function component may be achieved via a data exchange interface, for example.

### BRIEF DESCRIPTION OF THE DRAWINGS

FIG. 1 illustrates a terminal equipped with a removable function component, according to some embodiments.

FIG. 2 illustrates the front of a terminal, in some embodiments.

FIG. 3 illustrates that rear or backside of a terminal, in some embodiments.

FIG. 4 illustrates the removable function component embedded in the main screen device, according to some embodiments.

FIG. 5 illustrates a removable function component, according to some embodiments.

FIG. 6 illustrates a removable function component, according to some embodiments.

FIG. 7 illustrates a rear view of a removable function component, according to some embodiments.

FIGS. 8A-8B illustrates a bottom view and a top view, respectively, for a removable function component, according to some embodiments.

FIGS. 9A-9C illustrate example devices designed to accommodate various embodiments of a removable function module that implement embodiments of an appliance control component.

FIG. 10 illustrated a process of configuring one or more devices to operate in different mode, in some embodiments.

FIG. 11 illustrates a system diagram of a device, in accordance with some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . . ” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

### SYMBOL DESCRIPTION

1 HOME Key; 2 Touchable Screen; 3 Small Screen; 4 Flash Indication Key; 5 Camera; 6 Power Switch; 7 Volume Key; 8 Capture Key; 9 Receiver; 10 Microphone (MIC); 11 Locking Device; 12 Circuit Interface.

### INTRODUCTION

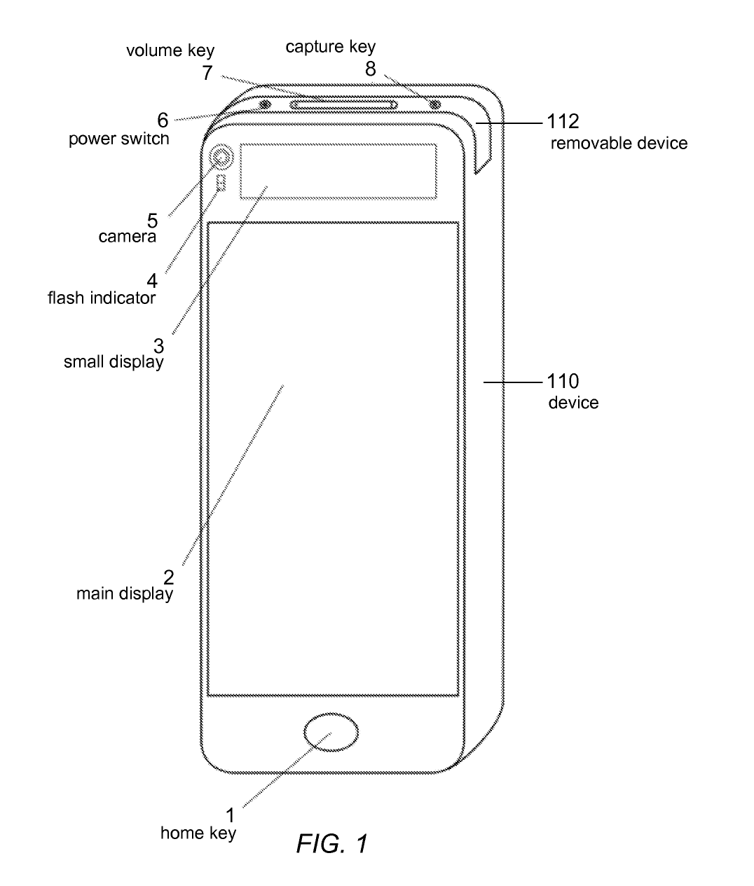

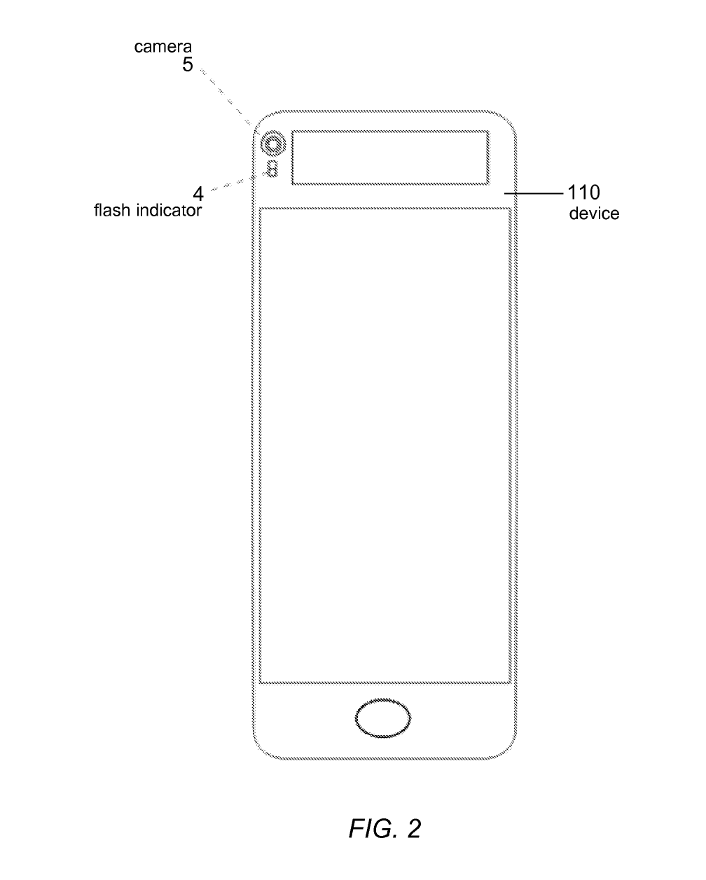

As shown in FIGS. 1, 2, 3, and 4, in some embodiments, an intelligent terminal equipped with removable function component includes a main screen device, a withdrawing apparatus 112 inside the main screen device 110. In some embodiments, a removable function component may be configured within the withdrawing apparatus 112. The illustrated withdrawing apparatus is configured with power supply interface and data exchange interface, in embodiments; the main screen device includes the touchable screen 2, audio devices 7 and memory. In embodiments, when the removable function component separates from the withdrawing apparatus, data exchange between the main screen device and removable function component is achieved via the data exchange interface. In some embodiments, when the removable function component separates from the withdrawing apparatus, the data exchange between the main screen device and the removable function component is achieved via wireless method.

In some embodiments, the main screen device can be provided with HOME Key 1, Touchable Screen 2, audio devices (e.g., volume key 7), memory, built-in battery and central processing unit. The main screen device can provide receiving and charging functions, in embodiments. The main screen device can be worked as the function extension component of the removable function component, or separate from the removable function component or worked independently offline, in embodiments. The main screen device can be used the removable function component peripherals of the built-in central processing unit, in embodiments.

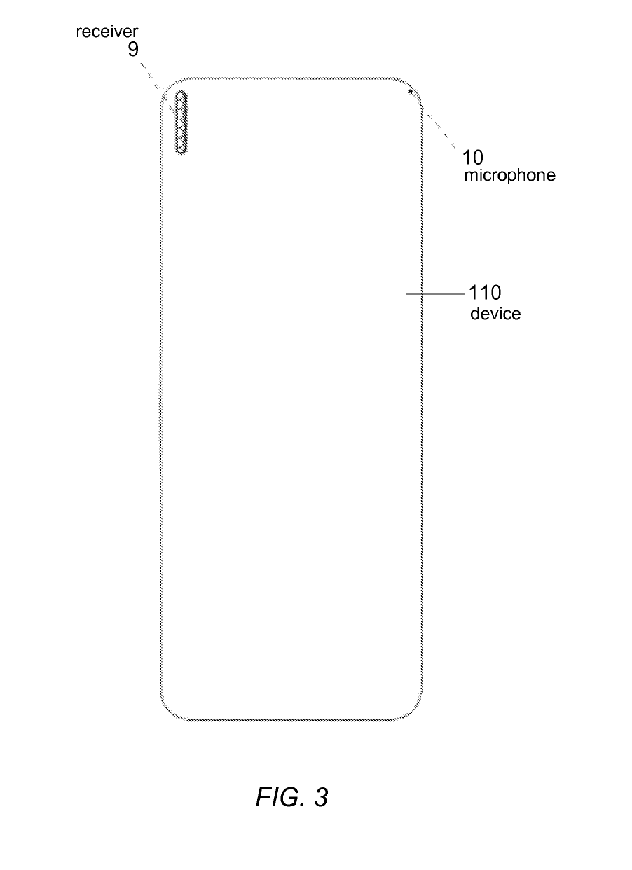

The terminal and/or the peripheral may include any number of features, such as a touchable screen 2 for providing display features and receiving touch-based inputs from a user, small screen 3 providing display features and receiving touch-based inputs from a user, flash indicator key 4, camera 5 for capturing images, power switch 6 for turning the device on/off, and/or capture key 8 for instructing the device to capture images. FIG. 3 illustrates a rear view of a device 110 with a receiver antenna 9 for converting electric power into radio waves, and vice versa, and microphone 10 for receiving audio signals.

A non-exhaustive list of physical forms of an intelligent terminal may be mobile phones, tablet PCs, laptops, desktop PCs, all-in-one PCs, monitors or TV.

If the main screen device is embedded with central processing unit, it can be used as the data processing center of the intelligent terminal, in embodiments. In embodiments, when used as the data processing center of the intelligent terminal, the removable function component can be used for the function extension and information collection device for the main screen device. The removable function component can be used offline or online, in embodiments.

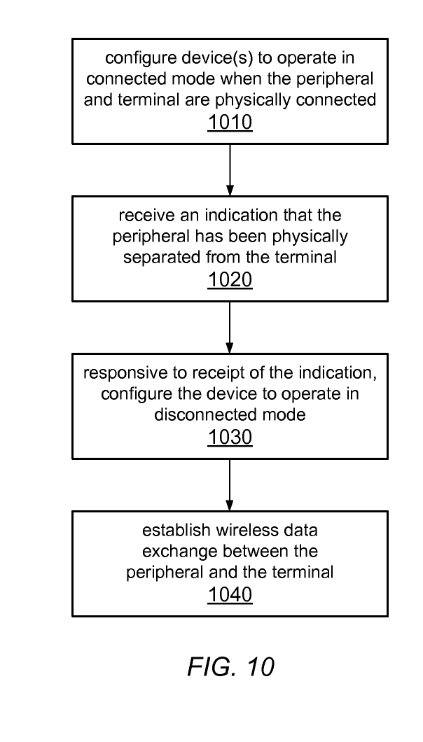

In embodiments, the so-called offline state refers to the disconnection state of the main screen device with the removable function component (a process associated with the disconnection state is illustrated in FIG. 10). It may refer to the state of the removable function component separating from the main screen device and wireless disconnection or the state of the removable function component being withdrawn from the main screen device and closing the wired connection. In the offline state, the removable function component can independently carry out all or part function operation or information collection, and store the data in the internal memory of removable function component, in embodiments. When the removable function component resumes the online state, the main screen device may read and handle data in the removable function component, and achieve data exchange or transfer with the removable function component, in embodiments. In the offline state, the main screen device can independently complete its function operation, in embodiments.

The so-called online state refers to the connection state of removable function component with the main screen device, in embodiments. It may be the state of the removable function component being withdrawn in the main screen device and keeping wired connection with the main screen device, or the state of the removable function component separating from the main screen device but keeping the wired connection. In the wired connection, the removable function component can be used as the extension component of the main screen device, in embodiments; in the wireless connection, the removable function component can be used as the main screen device peripherals, in embodiments.

If there is no built-in central processing unit in the main screen device, it is used as the independent display device of the intelligent terminal, in embodiments. In this case, the removable function component can be used as host of the intelligent terminal, and it may be used offline or online, in embodiments.

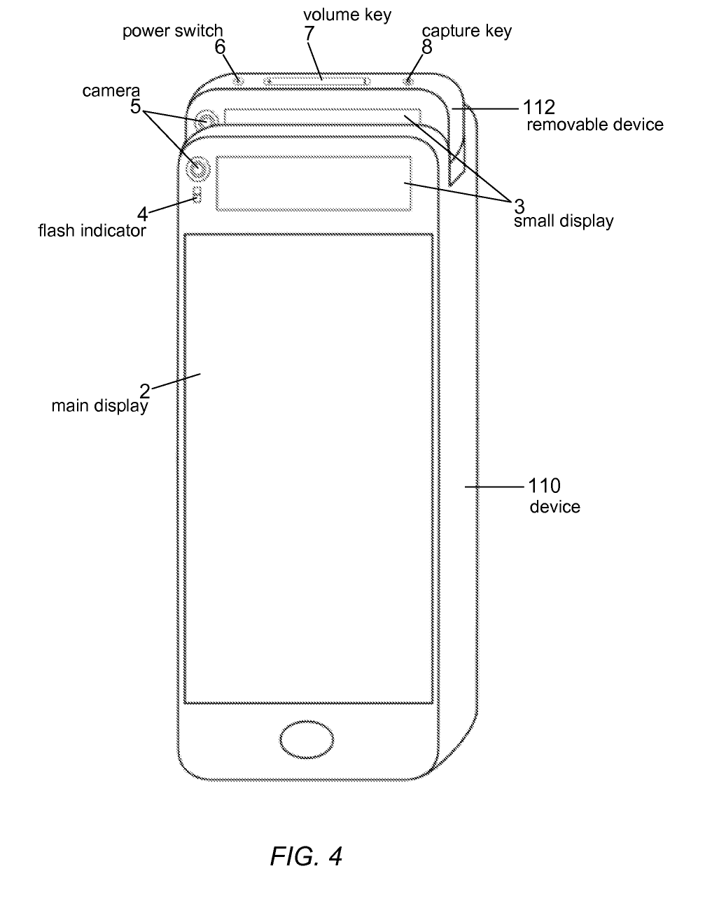

In some embodiments, the removable function component can be embedded in the withdrawing apparatus 112 of the main screen device. In the embodiment illustrated in FIG. 4, the place corresponding to the Small Screen 3 on the main screen device is a small window with the same size of Small Screen 3 of the withdrawing apparatus 112 or embedded in the withdrawing apparatus by other means.

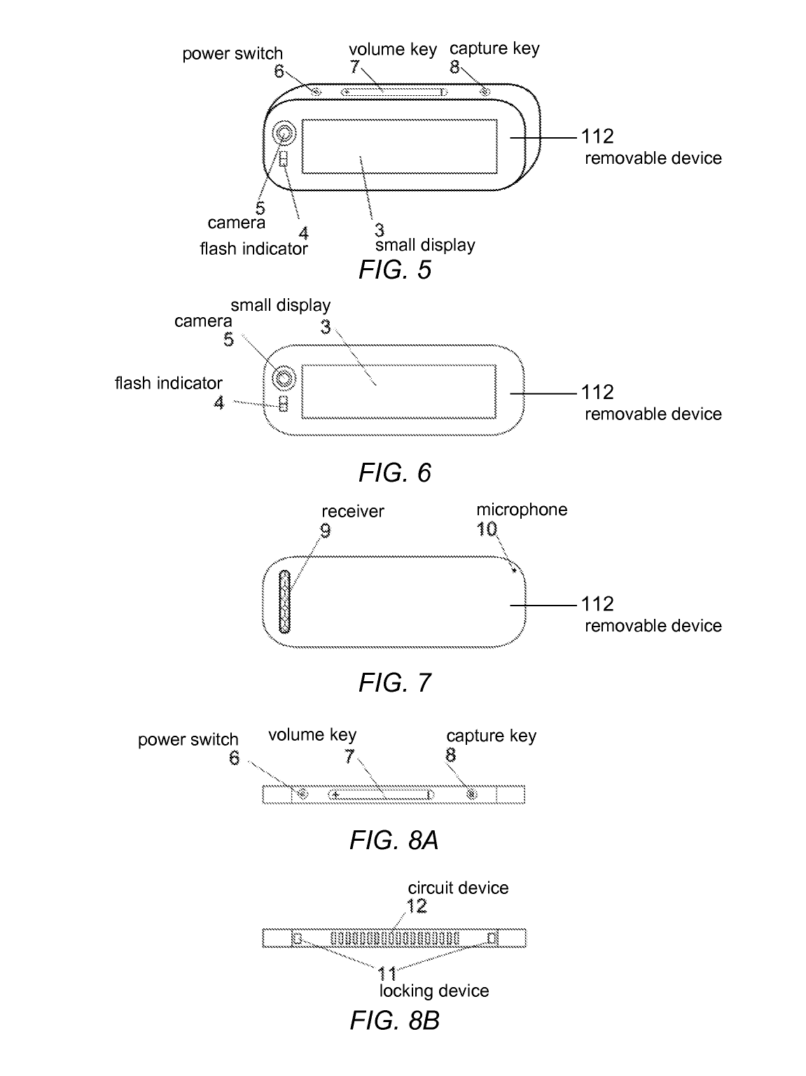

As shown in FIGS. 5 and 6, the front side of removable function component is provided with a Small Screen 3, Flash Indication Key 4, and Camera 5; the upper surface is provided with Power Switch 6, Volume Key 7, capture key 8; the bottom is provided with the locking device and circuit interface 12 for combining with the main screen device; the back side is provided with receiver/transmitter 9 and microphone (MIC) 11.

In embodiments, the removable function component or the peripheral device can be provided with Bluetooth headset, remote control, camera, smart wearable device, intelligent peripherals, multimedia players, smart peripherals, smart IC card, remote controller and/or an intelligent scanner, including but not limited to physical buttons, display screen, Bluetooth, Wi-Fi, camera, MIC, telephone receiver, GPS, motion sensors, environmental sensors, biosensors, image sensors, infrared radiation, NFC, memory, 3.5 mm headphone jack and the like.

The removable function component or the peripheral device can be used as a function extension component for the main screen device, or separate from the main screen device, or work independently offline, in embodiments. In some embodiments the removable function component or the terminal 110 may include a removable function module 1172. The removable function module may recognize when the terminal and peripheral separate and may perform functions associated with the separate, as described herein. For example, the removable function module may perform one, some or all of the process illustrated in FIG. 10, in embodiments.

In embodiments, one of the devices (the terminal or the peripheral) may include an alarm unit (e.g., alarm unit 1173). In embodiments an alarm unit may be configured to sound or instruct display of an alarm based on any of various criteria. Example criteria may include when a distance between the main screen device and the removable function component exceeds a set alarm distance. In such a case, the alarm unit may send an alarm signal instructing the alarm.

In embodiments, the removable function component connects with the main screen device via the interface in the withdrawing apparatus (e.g., achieving the wired charging and data exchange). When the removable function component is removed from the withdrawing apparatus, the removable function component may achieve wireless connection with the main screen device, in embodiments.

When the removable function component 112 is inserted into the withdrawing apparatus of the main screen device 110, the removable function component automatically achieves a wired connection with the main screen device, and the main screen device charges the function component according to the power condition of the removable function component, in embodiments.

When the removable function component is inserted in the main screen device and the main screen device charges through the external power supply, the removable function component and the main screen device can be charged together, in embodiments.

When the removable function component is inserted in the main screen device, the main screen device can set whether to charge the removable function component, in embodiments. Other functionality that can be configured or controlled includes turning on and turning off the power and/or the wired data connection with the removable function component, in embodiments.

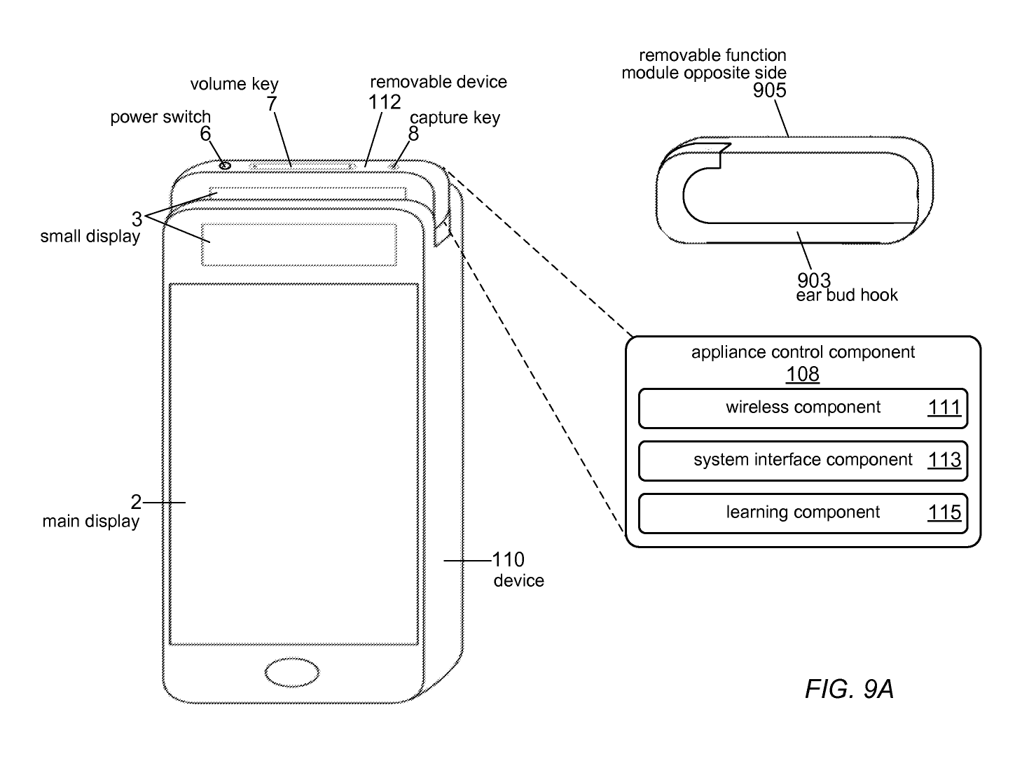

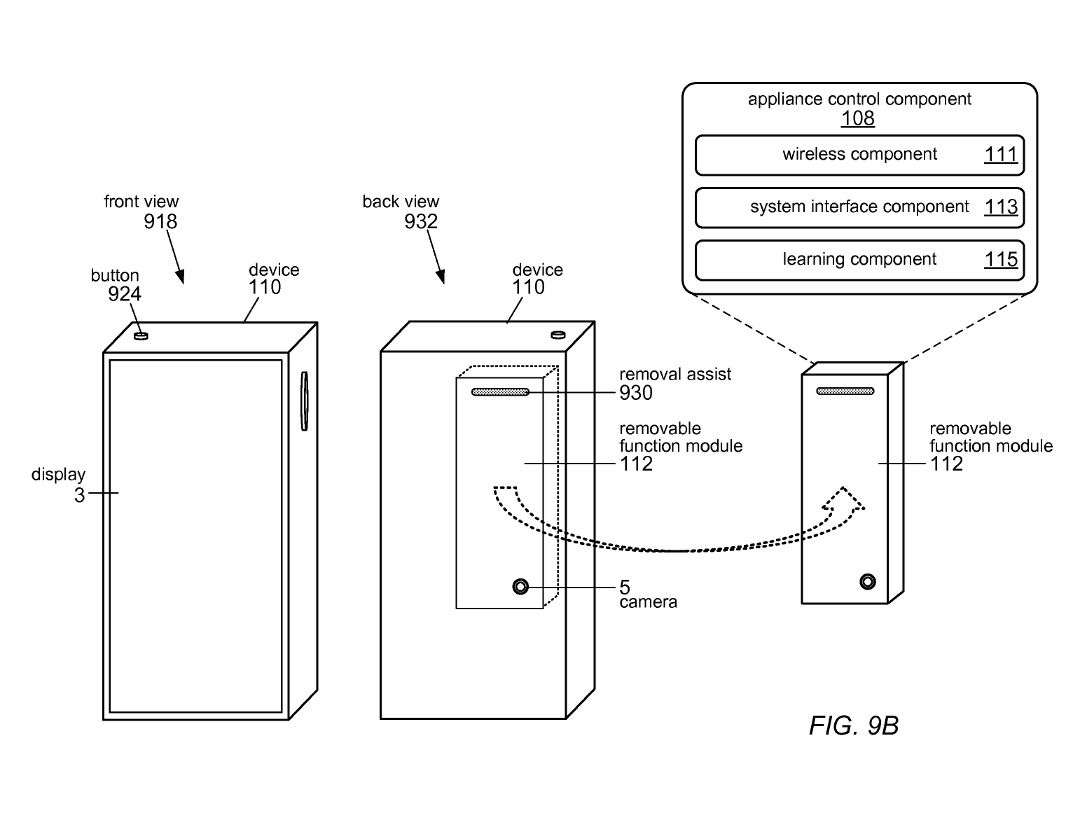

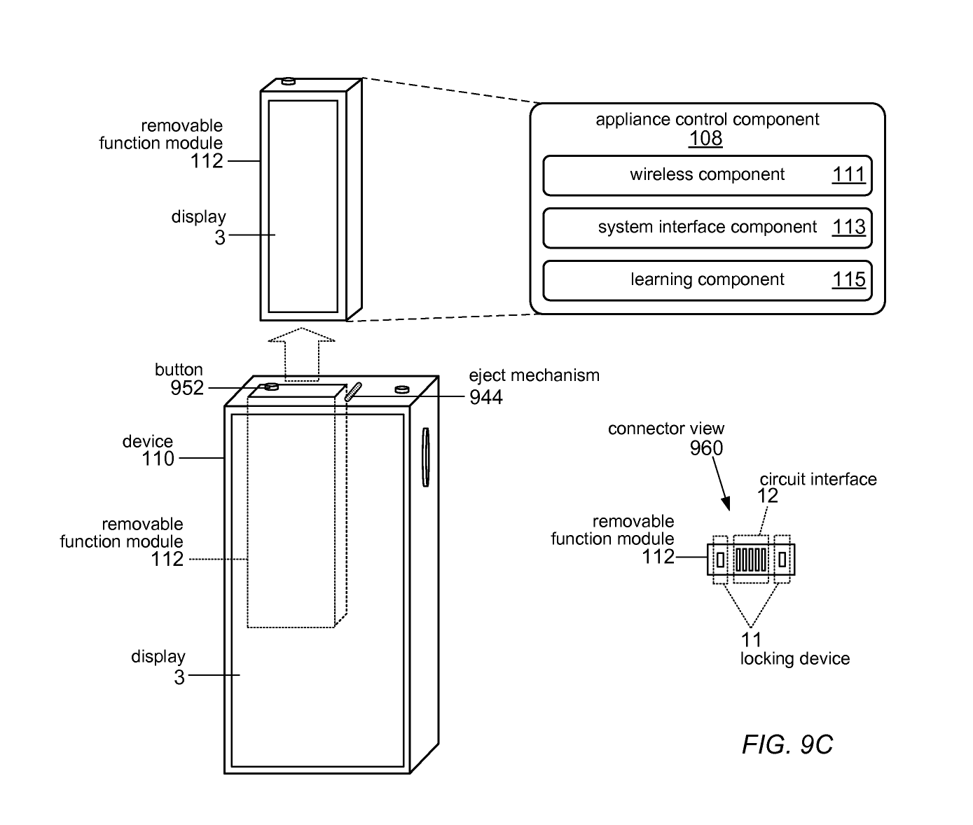

FIGS. 9A-9C illustrate example devices designed to accommodate various embodiments of a removable function module that implement embodiments of an appliance control component.

In embodiments, FIG. 9A illustrates a device 110 including a physical design feature (e.g., a button, selection switch, selectable interface element or the like) and an appliance control component 108 that provides an integrated control panel for controlling one or more appliances. Appliance control component 108 may include a wireless component, such as wireless component 111, for transmitting and receiving wireless signals, and may further include a system interface component, such as system interface component 113, which may communicate with a physical design feature of the device and which may interface with a device operating system. Appliance control component 108 may also include a learning component, such as learning component 115, which may provide features related to identifying patterns of appliance usage and inferring and determining patterns of behavior and corresponding rules.

In embodiments, FIG. 9A illustrates device 110, which may be designed to fit or accommodate the dimensions of removable function module 112. Removable function module 112 may also include one or more contacts corresponding to one or more contacts in device 110 such that removable function module 112 may lock in to place within the space of device 110.

In some cases, removable function module 112 may lock in to place with magnetic contacts. In other cases, removable function module 112 may include a pin connector and device 110 may include a corresponding female connection. In other cases, a different type of mechanism may lock removable function module 112 in to place within device 110, where when removable function module 112 is in a locked position, an interface between connectors of removable function module 112 and device 110 is enabled.

In some embodiments, removable function module 112 may include a volume control mechanism such as volume control 7 and a display such as display 3. Further, in this implementation, removable function module 112 may include a switch 6, which may operate similarly to switch 404 described with regard to FIG. 4.

In other examples, instead of switch 6, removable function module 112 may include a button, such as button 924 described with regard to FIG. 9B. In other examples, instead of switch 6, removable function module 112 may include another type of physical input mechanism configured to detect and receive tactile user input.

In some embodiments, removable function module 112 may include a power switch 8 that may power down, power up, or enable/disable a dormant state either when removable function module 112 is connected to device 110 or when removable function module 112 is disconnected from a device and operating independently. In some cases, when removable function module 112 is connected to device 110, content that would otherwise be displayed on display 3 may be displayed in display 3 of device 110.

Further in this example, when removable function module 112 is connected to device 110, the appliance control component implemented within removable function module 112 may interface with and display a control interface (e.g., within display 2). In this example, if the removable function module 112 is connected to device 110, then display 3 may be deactivated and all visual content that would be displayed in display 3 of device 112 may instead be transmitted from removable function module 112 to device 110 for display within display 3 of device 110.

In this example, an intelligent terminal such as device 110 may be equipped with removable function module 112. Device may include a main screen such as display 2 and a withdrawing apparatus as part of the device body. The withdrawing apparatus of device 110 may be installed with a power supply interface and a data exchange interface, and display 2 may also be a touchable screen. In some examples, when removable function module 112 is attached to the withdrawing apparatus of device 110, data exchange between device 110 and removable function module 112 may be achieved via the data exchange interface.

However, in other examples, when the removable function module 112 separates from the withdrawing apparatus of device 110, the data exchange between the main screen device and the removable function module may be achieved via any wireless communication, including Bluetooth. In some embodiments, removable function module 112 may include a power supply that may recharge when connected to device 110. Further, when the removable function module 112 is separate from the withdrawing apparatus of the device 110, removable function module 112 may be worn from an ear, where the ear bud hook 903 may swivel from a locked position (displayed) into an extended position (not displayed), as depicted the opposite side view of removable function module opposite side 905. In this way, removable function module 112 may be an independent Bluetooth device, or a wearable device using some other wireless protocol, including protocols for communicating via cellular phone networks. In other words, the removable function module 112 may serve as an independent, cellular device.

FIG. 9B illustrates a front view 918 of device 110 with a display 3 and button 924, where device 110 may be designed to fit or accommodate the dimensions of removable function module 112. Removable function module 112 may also include one or more contacts corresponding to one or more contacts and locking mechanisms such that removable function module 112 may lock in to place within the space of device 110.

In some cases, removable function module 112 may lock in to place with magnetic contacts. In other cases, removable function module 112 may include a pin connector and device 110 may include a corresponding female connection. In other cases, a different type of mechanism may lock removable function module 112 in to place within device 110, where when removable function module 112 is in a locked position, an interface between connectors of removable function module 112 and device 110 is enabled.

In some embodiments, removable function module 112 may include a volume control mechanism and a display. In this example, as depicted in back view 932, removable function module 112 includes a camera, camera 5, and also includes a removal assist mechanism, removal assist 930. In one example, removal assist 930 may be a cavity allowing a user to establish a hold and pull on the removable function module. In another example, removal assist 930 may a depressible eject mechanism.

Further, in this implementation, removable function module 112 may operate in conjunction with button 924 of device 110, which together may operate to implement an appliance control component according to embodiments described elsewhere.

In some embodiments, removable function module 112 may include a power switch that may power down, power up, or enable/disable a dormant state either when removable function module 112 is connected to device 110 or when removable function module 112 is disconnected from a device and operating independently.

Further in this example, when removable function module 112 is connected to device 110, the appliance control component implemented within removable function module 112 may interface with and display a control interface, such as control panel 106 of FIG. 1A, within display 3.

In this example, an intelligent terminal such as device 110 may be equipped with removable function module 112. Device 110 may include a withdrawing apparatus as part of the device body. The withdrawing apparatus of device 110 may be installed with a power supply interface and a data exchange interface, and display 3 may also be a touchable screen. In some examples, when removable function module 112 is attached to the withdrawing apparatus of device 110, data exchange between device 110 and removable function module 112 may be achieved via the data exchange interface.

However, in other examples, when the removable function module 112 separates from the withdrawing apparatus of device 110, the data exchange between the main screen device and the removable function module may be achieved via wireless communication. In some embodiments, removable function module 112 may include a power supply that may recharge when connected to device 110.

FIG. 9C illustrates a device 110 with a display 3 and eject mechanism 944, where device 110 may be designed to fit or accommodate the dimensions of removable function module 112. Removable function module 112 may also include one or more contacts corresponding to one or more contacts and locking mechanisms such that removable function module 112 may lock in to place within the space of device 110. In one example, eject mechanism 944 may be a depressible eject mechanism allowing a user to eject removable function module 112.

In some cases, removable function module 112 may lock in to place with magnetic contacts. In other cases, removable function module 112 may include a pin connector and device 110 may include a corresponding female connection. In other cases, a different type of mechanism may lock removable function module 112 in to place within device 110, where when removable function module 112 is in a locked position, an interface between connectors of removable function module 112 and device 110 may be established.

In some embodiments, removable function module 112 may include a button, such as button 952 and a display, such as display 3. Further in this example, when removable function module 112 is connected to device 110, the appliance control component implemented within removable function module 112 may interface with and display a control interface, such as a control panel (e.g., displayed within display 3). In this example, if the removable function module 112 is connected to device 110, then display 3 may be deactivated and all visual content that would be displayed in display 3 if removable function module 112 were operating independently may instead be transmitted from removable function module 112 to device 110 for display within display 3.

In some implementations, as depicted in connector view 960 of removable function module 112, removable function module 112 may include a locking device, locking device 11, where locking device 11 is designed to lock in to a corresponding locking mechanism of device 110. Further, in this example, removable function module 112 may include a circuit interface 12 for making contact with a corresponding circuit interface of device 110, and where circuit interface 12 may implement a data exchange and/or power charging functions in response to being connected to device 110.

Further, in this implementation, removable function module 112 may receive input from button 952 to operate to implement an appliance control component according to embodiments described elsewhere. In different embodiments, button 952 may be any of the types of physical design elements discussed elsewhere for receiving user input for invoking an appliance control component.

In some embodiments, removable function module 112 may include a power switch that may power down, power up, or enable/disable a dormant state either when removable function module 112 is connected to device 110 or when removable function module 112 is disconnected from a device and operating independently.

Further in this example, when removable function module 112 is connected to device 110, the appliance control component implemented within removable function module 112 may interface with and display a control interface, such as a control panel (e.g., within display 3 of device 110) when removable function module 112 is operating with device 110, and within display 3 when removable function module 112 is operating independently of any other device.

In this example, an intelligent terminal such as device 110 may be equipped with removable function module 112. Device 110 may include a withdrawing apparatus as part of the device body. The withdrawing apparatus of device 110 may be installed with a power supply interface and a data exchange interface, and display 3 may also be a touchable screen. In some examples, when removable function module 112 is attached to the withdrawing apparatus of device 110, data exchange between device 110 and removable function module 112 may be achieved via the data exchange interface.

However, in other examples, when the removable function module 112 separates from the withdrawing apparatus of device 110, the data exchange between the main screen device and the removable function module may be achieved via wireless communication. In some embodiments, removable function module 112 may include a power supply that may recharge when connected to device 110.

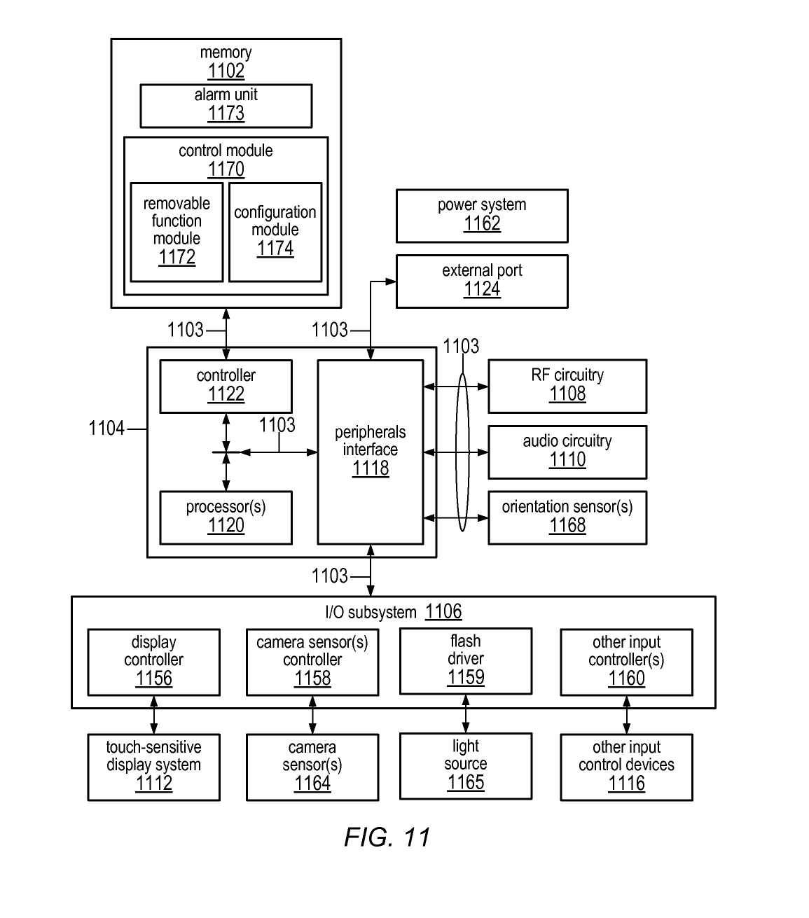

FIG. 10 illustrates a process for configuring one or more device to operate in various modes, according to some embodiments. In some embodiments, the device 110, terminal and/or peripheral may be configured to operate as illustrated. In some embodiments control software or hardware may be configured to perform one or more of the portions of the process illustrated. For example, a configuration module (e.g., configuration module 1174 in FIG. 11).

For example, at block 1010, one or more devices (e.g., device 110) are configured to operate in a connected mode when a peripheral and a terminal are physically connected. FIG. 1 illustrates a peripheral and a terminal that are physically connected, for example. In some embodiments, both the terminal and the peripheral may be configured to operate when physically connected. For example, the terminal may be configured to operate in a master mode and the peripheral in a slave mode, when physically connected. In some embodiments, either the terminal alone or the peripheral may be configured to operate when physically connected. In some embodiments, the particular mode may be configurable, a default or a user setting, for example.

At block 1020, an indication that the peripheral has been physically separated from the terminal may be received. Either or both of the terminal and/or the peripheral may receive the indication, in embodiments. Block 1030 illustrates that either or both devices (e.g. the terminal or peripheral) may respond to receipt of the indication by reconfiguring to operate in a disconnected mode. The disconnected mode may include any number of configuration changes to the device(s). For example, block 1040 illustrates that when either one of the terminal or peripheral are configured to operate in a disconnected mode, either one may establish a wireless data exchange between the two. The wireless data exchange may have not existed, or may have been turned off or may have been in a connected mode that establishes but does not use the wireless data exchange, in various embodiments.

FIG. 11 illustrates a system diagram of a device, in accordance with some embodiments. In some embodiments, FIG. 11 illustrates a terminal, while in other embodiments, FIG. 11 illustrates a withdrawing apparatus. In some embodiments, FIG. 11 illustrates device 110 with one or more camera sensors 1164 (e.g., image sensor 114), camera sensor controllers 1158 (e.g., image processor 618), flash driver 602, and light source 1165. These components may communicate over one or more communication buses or signal lines 1103. It should be appreciated that illustrated device is only one example of portions of a two-part device, and that the illustrated device may have more or fewer components than shown, may combine two or more components, or may have a different configuration or arrangement of the components. The various components shown in FIG. 11 may be implemented in hardware, software, or a combination of hardware and software, including one or more signal processing and/or application specific integrated circuits.

Memory 1102 may include high-speed random access memory and may also include non-volatile memory, such as one or more magnetic disk storage devices, flash memory devices, or other non-volatile solid-state memory devices. Access to memory 1102 by other components of the illustrated device, such as CPU/processor(s) 1120 and the peripherals interface 1118, may be controlled by memory controller 1122.

Peripherals interface 1118 can be used to couple input and output peripherals of the device to CPU 1120 and memory 1102. The one or more processor(s) 1120 run or execute various software programs and/or sets of instructions stored in memory 1102 to perform various functions for the illustrated device and to process data.

In some embodiments, peripherals interface 1118, CPU 1120, and memory controller 1122 may be implemented on a single chip, such as chip 1104. In some other embodiments, they may be implemented on separate chips. RF (radio frequency) circuitry 1108 receives and sends RF signals, also called electromagnetic signals. RF circuitry 1108 converts electrical signals to/from electromagnetic signals and communicates with communications networks and other communications devices via the electromagnetic signals. RF circuitry 1108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 1108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of multiple communications standards, protocols and technologies, including but not limited to Global System for Mobile Communications (GSM), Enhanced Data GSM Environment (EDGE), high-speed downlink packet access (HSDPA), high-speed uplink packet access (HSUPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

I/O subsystem 1106 couples input/output peripherals on the illustrated device, such as touch screen 1112 (e.g., part of user interface 118) and other input control devices 1116, to peripherals interface 1118. I/O subsystem 1106 may include display controller 1156 and one or more input controllers 1160 for other input or control devices. The one or more input controllers 1160 receive/send electrical signals from/to other input or control devices 1116. The other input control devices 1116 may include a physical buttons (e.g., push button such as 924 in FIG. 9B, rocker buttons, etc.), dials, slider switches, joysticks, click wheels, and so forth. In some alternate embodiments, input controller(s) 1160 may be coupled to any (or none) of the following: a keyboard, infrared port, USB port, and a pointer device such as a mouse.

Touch-sensitive display 1112 (e.g., part of user interface 118) provides an input interface and an output interface between the device and a user. Display controller 1156 receives and/or sends electrical signals from/to touch screen 1112. Touch screen 1112 displays visual output to the user. The visual output may include graphics, text, icons, video, and any combination thereof (collectively termed “graphics”). In some embodiments, some or all of the visual output may correspond to user-interface objects.

In embodiments, the system illustrated in FIG. 11 also includes power system 1162 for powering the various components. Power system 1162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The illustrated system may also include one or more optical sensors 1164 (e.g., image sensor 114). Optical sensors 1164 may include charge-coupled device (CCD) or complementary metal oxide semiconductor (CMOS) phototransistors. Optical sensors 1164 receives light from the environment, projected through one or more lens, and converts the light to data representing an image. Optical sensors 1164 may capture still images or video. In some embodiments, an optical sensor is located on the back of device 110, opposite touch screen display 1112 on the front of the device, so that the touch screen display may be used as a viewfinder for still and/or video image acquisition. In some embodiments, another optical sensor is located on the front of the device so that the user's image may be obtained for videoconferencing while the user views the other video conference participants on the touch screen display.

In embodiments, the illustrated system includes one or more orientation sensors 1168. In some embodiments, the one or more orientation sensors include one or more accelerometers (e.g., one or more linear accelerometers and/or one or more rotational accelerometers). In some embodiments, the one or more orientation sensors include one or more gyroscopes. In some embodiments, the one or more orientation sensors include one or more magnetometers. In some embodiments, the one or more orientation sensors include one or more of global positioning system (GPS), Global Navigation Satellite System (GLONASS), and/or other global navigation system receivers. The GPS, GLONASS, and/or other global navigation system receivers may be used for obtaining information concerning the location and orientation (e.g., portrait or landscape) of the illustrated device. In some embodiments, the one or more orientation sensors include any combination of orientation/rotation sensors. In some embodiments, the one or more orientation sensors 1168 may be coupled to an input controller 1160 in I/O subsystem 1106. In some embodiments, information is displayed on the touch screen display in a portrait view or a landscape view based on an analysis of data received from the one or more orientation sensors.

In some embodiments, the software components stored in memory 1102 include a control module 1170 (e.g., with a removable function module 1172 and/or configuration module 1174). The software components stored in memory 1102 may also include an operating system, communication module (or set of instructions), contact/motion module (or set of instructions), graphics module (or set of instructions), text input module (or set of instructions) Global Positioning System (GPS) module (or set of instructions), and applications (or sets of instructions) (all not illustrated). In some embodiments, the software components stored in memory 1102 may not include the removable function module 1172 and/or the configuration module 1174.

In conjunction with touch screen 1112, display controller 1156, camera sensor(s) 1164, camera sensor controller 1158 and a camera module (not illustrated) may include executable instructions to capture still images or video (including a video stream) and store them into memory 1102, modify characteristics of a still image or video, or delete a still image or video from memory 1102.

In conjunction with touch screen 1112, display controller 1156 and a camera module, an image management module (not illustrated) may include executable instructions to arrange, modify (e.g., edit), or otherwise manipulate, label, delete, present (e.g., in a digital slide show or album), and store still and/or video images.

In conjunction with touch screen 1112, display system controller 1156, a graphics module, audio circuitry, speaker and RF circuitry 1108, a media player module not illustrated) may include executable instructions that allow the user to download and play back recorded media and other sound files stored in one or more file formats, such as MP3 or AAC files, and executable instructions to display, present or otherwise play back videos (e.g., on touch screen 1112 or on an external, connected display via external port 1124).

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise rearranged in various embodiments. In some embodiments, memory 1102 may store a subset of the modules and data structures identified above. Furthermore, memory 1102 may store additional modules and data structures not described above.

In some embodiments, the illustrated device is a device where operation of a predefined set of functions on the device is performed exclusively through a touch screen and/or a touchpad. By using a touch screen and/or a touchpad as the primary input control device for operation of the device (e.g., device 110), the number of physical input control devices (such as push buttons, dials, and the like) on the device (e.g., device 110) may be reduced.

The predefined set of functions that may be performed exclusively through a touch screen and/or a touchpad include navigation between user interfaces. In some embodiments, the touchpad, when touched by the user, navigates the device to a main, home, or root menu from any user interface that may be displayed on the device (e.g., device 110). In such embodiments, the touchpad may be referred to as a “menu button.” In some other embodiments, the menu button may be a physical push button or other physical input control device instead of a touchpad.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g. as instructions or structured data) on a computer-accessible medium or a portable article to be read by an appropriate drive, various examples of which are described above. In some embodiments, instructions stored on a computer-accessible medium separate from the illustrated device may be transmitted to the illustrated device via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g. disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of embodiments as defined in the claims that follow.

1. A terminal comprising:
a main screen device comprising:
a touchable screen,
an audio device, and
a memory; and
a withdrawing apparatus configured to be removably withdrawn from the terminal, the withdrawing apparatus comprising:
a power supply interface,
a data exchange interface, and
a removable function component, wherein when the withdrawing apparatus separates from the main screen device, wireless data exchange between the main screen device and the removable function component is achieved via the data exchange interface, and wherein the wireless data exchange was not performed prior to the withdrawal of the withdrawing apparatus from the terminal.

2. The terminal of claim 1, wherein the main screen device charges the removable function component via a wired or wireless method.

3. The terminal of claim 2, wherein the terminal further comprises a battery, and wherein a charging current comes from the battery of the terminal or a motherboard current or an external power supply.

4. The terminal of claim 2, wherein the terminal further comprises a control device comprising a switch button configured to activate and deactivate the charging operation of the removable function component.

5. The terminal of claim 2, wherein the removable function component comprises a rechargeable battery, and wherein the wherein the wireless method is Wi-Fi, Bluetooth, infrared radiation or NFC.

6. The terminal of claim 1, wherein the terminal further comprises an external power supply that also charges the removable function component while charging the main screen device.

7. The terminal of claim 1, wherein the main screen device or the removable function component comprise an alarm unit, and wherein when a distance between the main screen device and the removable function component exceeds a set alarm distance, the alarm unit sends an alarm signal.

8. The terminal of claim 1, wherein the main screen device comprises a central processing unit, and wherein the removable function component comprises another central processing unit such that the removable function component works independently of the main screen device or works as an extension device of the main screen.

9. The terminal of claim 8, wherein the central processing unit of the main screen device and of the removable function component work simultaneously.

10. The terminal of claim 1, wherein the removable function component comprises a central processing unit such that the main screen device works as an extension device of the removable function component or works independently of the removable function component.

11. A method comprising:
achieving, responsive to withdrawal of a withdrawing apparatus from a terminal comprising a main screen device, wireless data exchange between the main screen device and a removable function component of the withdrawing apparatus via a wireless data exchange interface, wherein the wireless data exchange was not performed prior to the withdrawal of the withdrawing apparatus from the terminal.

12. The method of claim 11, further comprising:
charging, prior to withdrawal of the withdrawing apparatus removable from the terminal, the removable function component by the main screen device, wherein the charging comprises wired or wireless charging.

13. The method of claim 12, further comprising:
activating or deactivating the charging of the removable function component based at least in part on a switch button configured to control the charging of the removable function component.

14. The method of claim 11, further comprising:
sending an alarm signal, based at least in part on a distance between the main screen device and the removable function component exceeds a set alarm distance.

15. A removable function component comprising:
a screen; and
a data exchange interface, wherein when the removable function component separates from a main screen device, wireless data exchange between the main screen device and the removable function component is achieved, and wherein the wireless data exchange was not achieved prior to withdrawal of the removable function component from the main screen device.

16. The removable function component of claim 15, further comprising:
a battery, wherein prior to withdrawal of the removable function component from the main screen device, the battery of the removable function component is charged by the main screen device, wherein the charge is performed via a wired or wireless charging configuration.

17. The removable function component of claim 16, further comprising:
a switch button configured to control the charging of the battery of the removable function component, the switch button activating or deactivating the charging of the battery of the removable function component.

18. The removable function component of claim 15, further comprising:
an alarm unit configured to send an alarm signal based at least in part on whether a distance between the main screen device and the removable function component exceeds a set alarm distance.

19. The removable function component of claim 15, wherein the removable function component is a headset, remote control, camera, or multimedia player.

20. The removable function component of claim 15, further comprising a central processing unit configured to work simultaneously with a central processing unit of the main screen device.
